(19) United States
(12) Patent Application Publication
(10) Pub. No.: US 2021/0308685 A1
(43) Pub. Date: Oct. 7, 2021

(54) NUCLEIC ACID AMPLIFICATION DEVICE HAVING A PLURALITY OF HEATING BLOCKS

(71) Applicant: MICO BIOMED CO., LTD., Seongnam-si, Gyeonggi-do (KR)

(72) Inventors: Sung Woo KIM, Seoul (KR); Eun Sub KIM, Bucheon-si, Gyeonggi-do (KR); Song Gyun JUNG, Bucheon-si, Gyeonggi-do (KR); Jae Young BYUN, Bucheon-si, Gyeonggi-do (KR); Jin Keun HAN, Pyeongtaek-si, Gyeonggi-do (KR)

(21) Appl. No.: 17/264,697

(22) PCT Filed: Jul. 31, 2019
(86) PCT No.: PCT/KR2019/009520

§ 371 Date: Jan. 29, 2021

(30) Foreign Application Priority Data
Aug. 1, 2018 (KR) 10-2018-0090065

(51) Int. Cl. B01L 7/00; B01L 3/00; B01L 9/00

(52) U.S. Cl. CPC B01L 7/5255; B01L 3/502761; B01L 2300/1805; B01L 2200/0663; B01L 2200/14; B01L 9/527

(57) ABSTRACT

One aspect of the present invention provides a nucleic acid amplification device. The nucleic acid amplification device includes a polymerase chain reaction (PCR) chip driving portion configured to allow a PCR chip to reciprocate between a first position and a second position; a plurality of first heating blocks disposed to be spaced apart with the first position as a center therebetween and to face each other; a plurality of second heating blocks disposed to be spaced apart with the second position as a center therebetween and to face each other; and a heating block driving portion configured to move the plurality of first heating blocks and the plurality of second heating blocks toward the PCR chip. Here, both surfaces of the PCR chip come into contact with the plurality of first heating blocks at the first position and the both surfaces sequentially come into contact with the plurality of second heating blocks at the second position so as to perform PCR.

This application claims priority to and the benefit of Korean Patent Application No. 10-2018-0090065, filed on Aug. 1, 2018, the disclosure of which is incorporated herein by reference in its entirety.

### TECHNICAL FIELD

The present invention relates to a nucleic acid amplification device including a plurality of heating blocks and having improved heat efficiency.

### BACKGROUND ART

Polymerase chain reaction (PCR) is a method in which a series of copies of a part of nucleic acid, which has a particular nucleic sequence, is made by repetitively heating and cooling a solution sample including the nucleic acid so as to exponentially amplify the nucleic acid having the particular nucleic sequence part and which is widely used for analysis and diagnosis in the fields of life sciences, genetic engineering, medicine, and the like.

Recently, a variety of PCR devices configured to perform PCR have been developed. As an example, in a PCR device, a container including a solution sample including nucleic acid is mounted in one reaction chamber and PCR is performed by repetitively heating and cooling the container. However, since the PCR device according to the example includes one reaction chamber, an entire structure is not complicated but a complicated circuit for precisely controlling a temperature is necessary. Also, an entire time of an entire PCR necessarily increases due to repetitive heating and cooling of the one reaction chamber. Also, in a PCR device according to another example, a plurality of reaction chambers at a temperature for PCR are installed and a solution sample including nucleic acid is allowed to flow through one channel passing through the reaction chambers so as to perform PCR.

However, since the PCR device according to another example utilizes the plurality of reaction chambers, a complicated circuit for precisely controlling a temperature is unnecessary but a long flow path for passing through the reaction chambers at a high temperature and a low temperature is absolutely necessary such that an entire structure is inevitably complicated. Also, an additional controller configured to control a flow speed of the solution sample including the nucleic acid which flows through the channel passing through the reaction chambers is required.

Accordingly, it is necessary to provide a PCR device having an overall simple structure, minimizing overall PCR time, and obtaining a reliable PCR yield.

### DISCLOSURE

### Technical Problem

The present invention is directed to providing a nucleic acid amplification device in which heat efficiency of heating blocks is improved.

It should be noted that objects of the present invention are not limited to the above-described objects, and other objects of the present invention will be apparent to those skilled in the art from the following descriptions.

### Technical Solution

One aspect of the present invention provides a nucleic acid amplification device. The nucleic acid amplification device includes a polymerase chain reaction (PCR) chip driving portion configured to allow a PCR chip to reciprocate between a first position and a second position; a plurality of first heating blocks disposed to be spaced apart with the first position as a center therebetween and to face each other; a plurality of second heating blocks disposed to be spaced apart with the second position as a center therebetween and to face each other; and a heating block driving portion configured to move the plurality of first heating blocks and the plurality of second heating blocks toward the PCR chip. Here, both surfaces of the PCR chip come into contact with the plurality of first heating blocks at the first position and the both surfaces sequentially come into contact with the plurality of second heating blocks at the second position so as to perform PCR.

Specifically, the plurality of first heating blocks may be implemented to maintain a temperature of a denaturing step of the PCR or to maintain a temperature of annealing and extension steps of the PCR. The plurality of second heating blocks may be implemented to maintain the temperature of annealing and extension steps of the PCR or maintain the temperature of the denaturing step of the PCR. The plurality of first heating blocks and the plurality of second heating blocks may be implemented to maintain temperatures of different steps.

Specifically, the plurality of first heating blocks may be implemented to maintain the temperature of the denaturing step of the PCR, and the plurality of second heating blocks may be implemented to maintain the temperature of the annealing and extension steps of the PCR.

Specifically, the plurality of first heating blocks may be implemented to maintain the temperature of the annealing and extension steps of the PCR, and the plurality of second heating blocks may be implemented to maintain the temperature of the denaturing step of the PCR.

Also, specifically, the temperature of the denaturing step may be 90° C. to 100° C., and the temperature of the annealing and extension steps may be 45° C. to 75° C.

Also, specifically, each of the heating blocks may further include a main heating block having one surface coming into contact with the PCR chip; and an auxiliary heating block having one surface coming into contact with the other surface of the main heating block and having the other surface exposed outward.

Also, specifically, the main heating block may be implemented to have a first temperature, and the auxiliary heating block may be implemented to have a second temperature lower than the first temperature.

Also, specifically, the first temperature may be 90° C. to 100° C., and the second temperature may be 60° C. to 70° C.

Also, specifically, the first temperature may be 45° C. to 75° C., and the second temperature may be 25° C. to 45° C.

Also, specifically, the second temperature may be lower than the first temperature by 25° C. to 35° C.

Also, specifically, the second temperature may be between the first temperature and ambient temperature.

Also, specifically, the nucleic acid amplification device may further include the PCR chip including an inlet portion into which a solution sample is injected; a reaction chamber in which PCR of the solution sample is performed; and an outlet portion through which the solution sample is discharged.

Also, specifically, the nucleic acid amplification device may further include a PCR chip case configured to accommodate the PCR chip, expose the reaction chamber of the PCR chip to the outside, and reciprocate due to the PCR chip driving portion.

Also, specifically, the nucleic acid amplification device may further include a sealing portion having a soft material, coupled to the PCR chip to seal the inlet portion and the outlet portion of the PCR chip, and accommodated in the PCR chip case.

Another aspect of the present invention provides a nucleic acid amplification device. The nucleic acid amplification device includes a plurality of heating blocks disposed to be spaced apart and configured to come into contact with a PCR chip to perform PCR. Here, each of the heating blocks may include a main heating block having one surface coming into contact with the PCR chip; and an auxiliary heating block having one surface coming into contact with the other surface of the main heating block and having the other surface exposed outward.

The main heating block may be implemented to have a first temperature, and the auxiliary heating block may be implemented to have a second temperature lower than the first temperature.

### Advantageous Effects

According to the present invention, a polymerase chain reaction (PCR) device including a plurality of heating blocks may be provided to efficiently perform nucleic acid amplification reaction. Particularly, reaction velocity and efficiency of PCR may be improved by allowing the heating blocks to come into contact with both surfaces of a PCR chip.

Also, according to the present invention, each of the heating blocks may have a dual configuration including a main heating block and an auxiliary heating block, and stepwise temperatures may be formed with respect thereto. Accordingly, heat capacity and heat transfer efficiency of the main heating block and the auxiliary heating block may be improved and a life of the heating blocks may be significantly improved.

### DESCRIPTION OF DRAWINGS

A brief description of the drawings will be provided to more fully understand the drawings referred to in the detailed description of the present invention.

FIG. 1 illustrates a nucleic acid amplification device including a plurality of heating blocks according to one embodiment of the present invention.

FIGS. 2A to 2D illustrate operations of the nucleic acid amplification device according to one embodiment of the present invention.

FIG. 3 illustrates a nucleic acid amplification device according to one embodiment of the present invention.

FIG. 4A illustrates a heating block according to one embodiment of the present invention, and FIGS. 4B and 4C illustrate experimental data of the heating block.

FIG. 5 illustrates a chip holder of the nucleic acid amplification device according to one embodiment of the present invention.

FIGS. 6 to 8B illustrate a PCR chip package according to one embodiment of the present invention.

### MODES OF THE INVENTION

Hereinafter, embodiments of the present invention will be described with reference to the attached drawings. While reference numerals are given to components of each drawing, it should be noted that although shown in different drawings, like components will be referred to as like reference numerals if possible. Also, in a description of the embodiments of the present invention, a detailed description of well-known components or functions of the related art will be omitted when it is deemed to obscure understanding of the embodiments of the present invention. Also, although the embodiments of the present invention will be described below, the technical concept of the present invention is not limited or restricted thereto and a variety of modifications thereof may be made by one of ordinary skill in the art. Meanwhile, vertical and lateral directions which will be described below are on the basis of the drawings for convenience, and the scope of the present invention is not limited to the corresponding directions.

Throughout the specification, when a part is stated as being “connected” to another part, the part is not only “directly connected” but also “indirectly connected” to the other component with another device therebetween. Throughout the specification, when a portion is stated as “including” a component, unless defined particularly otherwise, it means that the portion may not exclude another component but may further include another component. Also, in describing components of the embodiments of the present invention, the terms such as first, second, A, B, (a), (b), and the like may be used. These terms are merely for distinguishing one element from another, and the essence, order, sequence, and the like of corresponding elements are not limited by the terms.

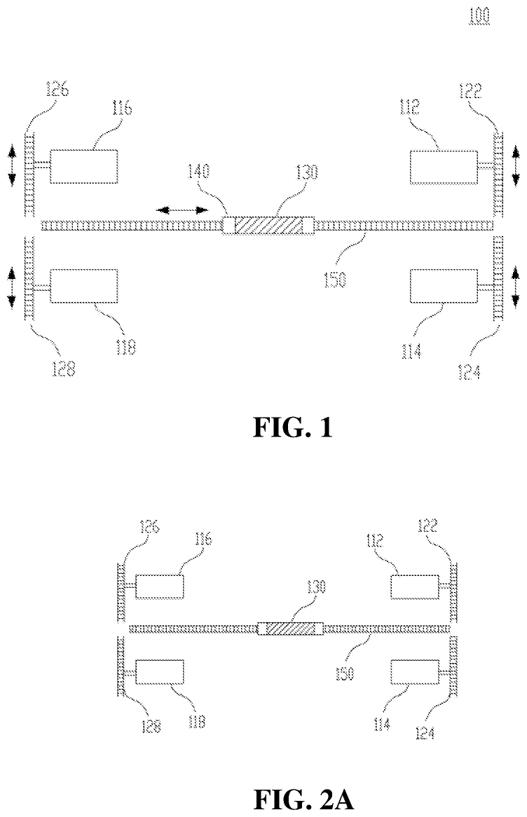

FIG. 1 illustrates a nucleic acid amplification device including a plurality of heating blocks according to one embodiment of the present invention.

A nucleic acid amplification device 100 is a device to be used for polymerase chain reaction (PCR) of amplifying nucleic acid having a particular nucleic sequence. For example, the device 100 may exponentially amplify deoxyribonucleic acid (DNA) having a particular nucleic sequence by repetitively performing a process, for example, twenty times to forty times that includes a denaturing step of heating a solution sample including double-stranded DNA at a particular temperature, for example, about 95° C. to separate the double-stranded DNA into single-stranded DNA, an annealing step of providing an oligonucleotide primer having a complementary sequence to a particular nucleic sequence to be amplified to the solution sample, cooling with the separated single-stranded DNA at a particular temperature, for example, 55° C., and coupling the primer to the particular nucleic sequence of the single-stranded DNA so as to form a partial DNA-primer compound, and an extension (or amplification) step of maintaining, after the annealing step, the solution sample at an adequate temperature, for example, 72° C., so as to form double-stranded DNA on the basis of the primer of the partial DNA-primer compound using DNA polymerase.

In detail, the device 100 may include heating blocks 112, 114, 116, and 118, heating block driving portions 122, 124, 126, and 128, a PCR chip 130, a chip holder 140, and a PCR chip driving portion 150.

The heating blocks 112, 114, 116, and 118 may include a plurality of first heating blocks 112 and 114 and a plurality of second heating blocks 116 and 118. In detail, the plurality of first heating blocks 112 and 114 may be disposed to be spaced apart with a first position as a center therebetween, and the plurality of second heating blocks 116 and 118 may be disposed to be spaced apart with a second position as a center therebetween which differs from the first position.

Also, each of the plurality of first heating blocks 112 and 114 may move toward the first position or move outward from the first position. Similarly, each of the plurality of second heating blocks 116 and 118 may also move toward the second position or move outward from the second position. Here, the first position and the second position may mean a path on which the PCR chip 130 moves. Through the movement of the first heating blocks 112 and 114 and the second heating blocks 116 and 118, the PCR chip 130 may come into sequential contact with the first heating blocks 112 and 114 and the second heating blocks 116 and 118.

Also, as described below in more detail, each of the heating blocks 112, 114, 116, and 118 may be implemented as a combination of a plurality of subordinate heating blocks and may be formed by combining, for example, a main heating block and an auxiliary heating block.

The first heating blocks 112 and 114 and the second heating blocks 116 and 118 are configured to maintain temperatures for the denaturing step, annealing step, and extension (amplification) step to amplify nucleic acid. The first heating blocks 112 and 114 and the second heating blocks 116 and 118 may include a variety of modules configured to provide and maintain the temperatures necessary for the respective steps or may be drivably connected to the modules.

When the PCR chip 130 or the chip holder 140 on which the PCR chip 130 is mounted comes into contact with one surface of each of the heating blocks 112, 114, 116, and 118, the first heating blocks 112 and 114 and the second heating blocks 116 and 118 may heat an overall contact surface of the PCR chip 130 and maintain a temperature thereof so as to uniformly heat the solution sample in the PCR chip 130 and maintain a temperature thereof.

In comparison to a device using a conventional single heating block in which a temperature change rate is within a range of 3 to 7° C. per second, in the present invention, since a temperature change rate in each of the heating blocks 112, 114, 116, and 118 is within a range of 20 to 40° C. per second, it is possible to significantly reduce a PCR time.

The first heating blocks 112 and 114 may be implemented to maintain an adequate temperature for performing the denaturing step or annealing and extension (or amplification) steps. For example, the first heating blocks 112 and 114 may maintain a temperature of 45° C. to 100° C. When the first heating blocks 112 and 114 perform the denaturing step, a temperature of 90° C. to 100° C. may be maintained. On the other hand, when the first heating blocks 112 and 114 perform the annealing and extension (or amplification) steps, a temperature of 45° C. to 75° C. may be maintained.

Similarly, the second heating blocks 116 and 118 may also be implemented to maintain an adequate temperature for performing the denaturing step or annealing and extension (or amplification) steps. For example, the second heating blocks 116 and 118 may maintain a temperature of 45° C. to 100° C. When the second heating blocks 116 and 118 perform the denaturing step, a temperature of 90° C. to 100° C. may be maintained. On the other hand, when the second heating blocks 116 and 118 perform the annealing and extension (or amplification) steps, a temperature of 45° C. to 75° C. may be maintained.

Temperatures at which the first heating blocks 112 and 114 and the second heating blocks 116 and 118 can perform the denaturing step or the annealing and extension (or amplification) steps are not limited thereto. However, the first heating blocks 112 and 114 and the second heating blocks 116 and 118 may be implemented to maintain different temperatures to perform different steps.

The first heating blocks 112 and 114 and the second heating blocks 116 and 118 may be disposed to be spaced at predetermined distances apart so as to prevent mutual heat exchange therebetween. Accordingly, since heat exchange does not occur between the first heating blocks 112 and 114 and the second heating blocks 116 and 118, it is possible to precisely control temperatures of the denaturing step and the annealing and extension (or amplification) steps in a nucleic acid amplification reaction which receives a significant influence from a minute temperature change.

The heating block driving portions 122, 124, 126, and 128 are connected to the first heating blocks 112 and 114 and the second heating blocks 116 and 118, respectively, so as to move the heating blocks 112, 114, 116, and 118 simultaneously or separately. That is, the heating block driving portions 122, 124, 126, and 128 may move the heating blocks 112, 114, 116, and 118 toward the PCR chip 130 to allow the heating blocks 112, 114, 116, and 118 to come into contact with the PCR chip 130 or to be farther away from the PCR chip 130 to move the PCR chip 130. The first heating blocks 112 and 114 and the second heating blocks 116 and 118 are allowed, by the heating block driving portions 122, 124, 126, and 128, to sequentially come into contact with the PCR chip 130 so as to perform PCR. For example, the heating block driving portions 122, 124, 126, and 128 are implemented with respect to the heating blocks 112, 114, 116, and 118 and may include rails configured to guide movement paths of the heating blocks 112, 114, 116, and 118 and operation portions including motor members configured to move the heating blocks on the rails but are not limited thereto.

The PCR chip 130 may come into contact with one surface of each of the first heating blocks 112 and 114 and the second heating blocks 116 and 118 and may include a solution sample including nucleic acid, for example, double-stranded DNA, oligonucleotide primer having a complementary nucleic sequence to a particular nucleic sequence to be amplified, DNA polymerase, deoxyribonucleotide triphosphates (dNTP), and a PCR buffer. The PCR chip 130 may include an inlet portion into which the solution sample is injected, a reaction chamber (or channel) in which nucleic acid amplification reaction of the solution sample is performed, and an outlet portion configured to discharge the solution sample on which the nucleic acid amplification reaction is completely performed. When the PCR chip 130 comes into contact with the first heating blocks 112 and 114 or the second heating blocks 116 and 118, heat of the first heating blocks 112 and 114 or the second heating blocks 116 and 118 may be transferred to the PCR chip 130 and the solution sample included in the reaction chamber (or channel) of the PCR chip 130 may be heated and a temperature thereof may be maintained. Also, the PCR chip 130 may have a flat panel shape overall but is not limited thereto. Also, an outer wall of the PCR chip 130 may have a shape and a structure to be fixedly mounted in an internal space of the chip holder 140 to prevent the PCR chip 130 from being detached from the chip holder 140 when the nucleic acid amplification reaction is performed.

The chip holder 140 may provide a space in which the PCR chip 130 is stably mounted and may transfer movement caused by the driving portion to the PCR chip 130. An inner wall of the chip holder 140 may have a shape and a structure to be fixedly mounted on the outer wall of the PCR chip 130 to prevent the PCR chip 130 from being detached from the chip holder 140 when the nucleic acid amplification reaction is performed.

The PCR chip driving portion 150 may include all means configured to allow the chip holder 140, on which the PCR chip 130 is mounted, to be movable between the first heating blocks 112 and 114 and the second heating blocks 116 and 118. In detail, the PCR chip driving portion 150 may move the chip holder 140 to the first position or the second position so as to allow the PCR chip 130 mounted on the chip holder 140 to come into sequential contact with the first heating blocks 112 and 114 and the second heating blocks 116 and 118 at each position. For example, the PCR chip driving portion 150 may include a rail extending in a lateral direction and an operation portion including a motor member configured to move the chip holder 140 through the rail but is not limited thereto.

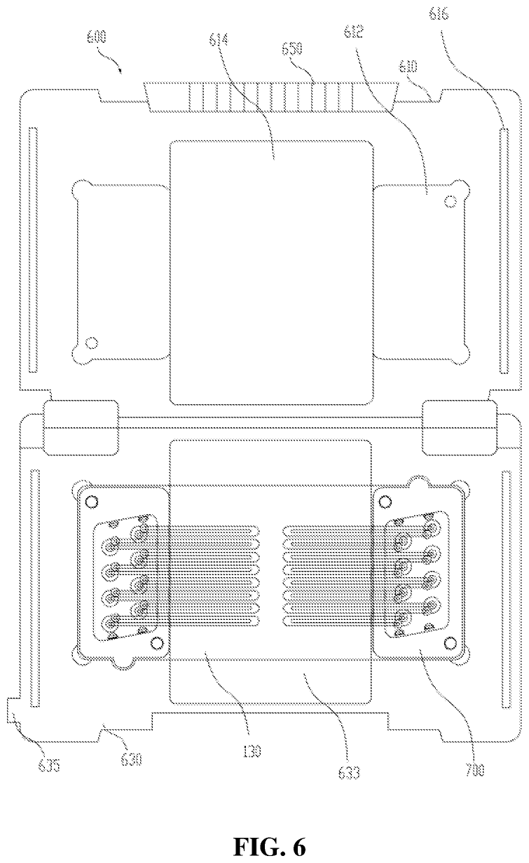

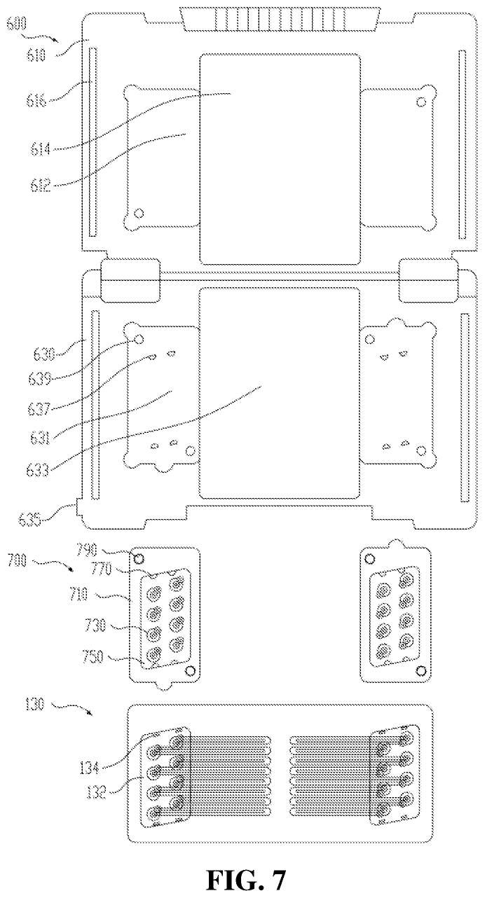

Although the PCR chip 130 is shown as being mounted on the chip holder 140 in FIG. 1, this is merely an example and a PCR chip package, which will be described below with reference to FIGS. 6 and 7, may be mounted on the chip holder 140 according to an embodiment. Although the PCR chip 130 is described as being disposed on the chip holder 140 for convenience in the present invention, this includes the PCR chip 130 being disposed separately or being disposed as a shape of the PCR chip package.

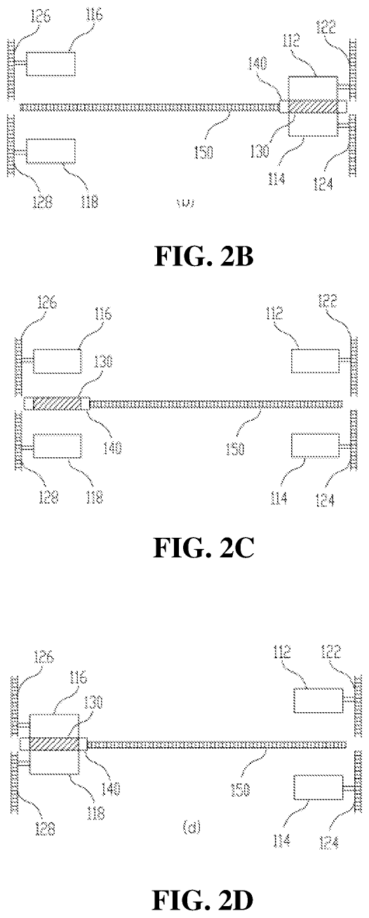

FIGS. 2A to 2D illustrate operations of the nucleic acid amplification device according to one embodiment of the present invention.

Referring to FIG. 2A, the first heating blocks 112 and 114 may be heated and maintained at a temperature for the denaturing step, for example, 90° C. to 100° C. The second heating blocks 116 and 118 may be heated and maintained at a temperature for the annealing and extension (or amplification) steps, for example, 45° C. to 75° C. Here, as shown in the drawings, the chip holder 140 may be placed in a neutral position between the first heating blocks 112 and 114 and the second heating blocks 116 and 118, which is merely an example, and the chip holder 140 may be placed at a random position between the first heating blocks 112 and 114 and the second heating blocks 116 and 119.

Subsequently, referring to FIG. 2B, the PCR chip driving portion 150 may move the chip holder 140 to the first position. Accordingly, when the PCR chip 130 is located at the first position, the first heating blocks 112 and 114, which are disposed to be spaced apart with the first position at a center therebetween to face each other, may be moved, by the heating block driving portions 122 and 124, toward the PCR chip 130 and may come into thermal contact with the PCR chip 130. Accordingly, a first denaturing step of PCR may be performed.

Subsequently, referring to FIG. 2C, the heating block driving portions 122 and 124 may move the first heating blocks 112 and 114 to be farther away from the PCR chip 130. Accordingly, when contact with the first heating blocks 112 and 114 is released, the first denaturing step of PCR may be finished and the PCR chip driving portion 150 may move the PCR chip 130 to the second position.

Referring to FIG. 2D, the heating block driving portions 126 and 128 may move the second heating blocks 116 and 118, which are disposed to be spaced apart with the second position as a center therebetween to face each other, toward the PCR chip 130. Accordingly, when the second heating blocks 116 and 118 come into thermal contact with the PCR chip 130, first annealing and extension (or amplification) steps of PCR may be performed.

Finally, the first annealing and extension (or amplification) steps of PCR may be finished by separating the PCR chip 130 from the second heating blocks 116 and 118 using the heating block driving portions 126 and 128 so as to complete a first cycle of PCR. The PCR may be performed a plurality of times.

As described above, in the present invention, the PCR chip 130 may come into sequential contact with the first heating blocks 112 and 114 and the second heating blocks 116 and 118 so as to perform the PCR. Here, the plurality of first heating blocks 112 and 114 may be provided and the plurality of second heating blocks 116 and 118 may also be provided so as to allow both sides of the PCR chip 130 to come into thermal contact with the heating blocks 112, 114, 116, and 118.

That is, since both surfaces of the PCR chip 130 come into thermal contact with the heating blocks 112, 114, 116, and 118 unlike a conventional case in which only one surface of a PCR chip is in thermal contact, heat efficiency may be improved and reaction velocity and efficiency of PCR may also be improved.

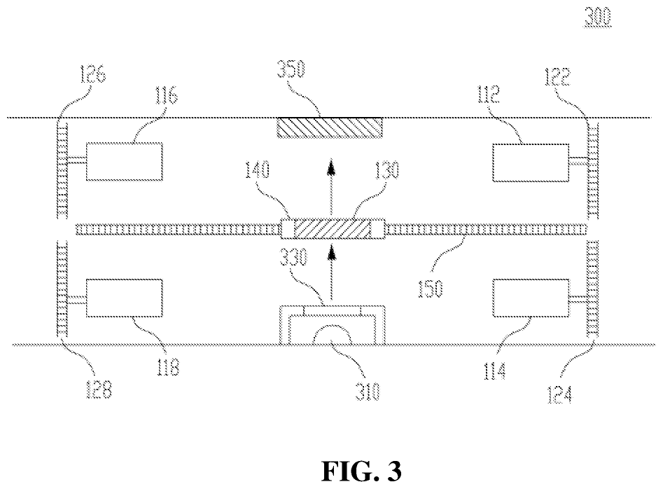

FIG. 3 illustrates a nucleic acid amplification device according to one embodiment of the present invention.

Referring to FIG. 3, a device 300 may further include a light source 310, a light filter 330, and a detection portion 350.

The light source 310 may be located between the heating blocks 112, 114, 116, and 118 and emit light toward the PCR chip 130. The light source 310 may be selected from the group consisting of a mercury arc lamp, a xenon arc lamp, a tungsten arc lamp, a metal halide arc lamp, metal halide fibers, light emitting diodes (LED), and photo diodes. Also, a wavelength of the light source 310 may be selected within a range from about 200 nm to 1300 nm or may be implemented as multiple wavelengths using multiple light source 310 or a filter.

The light filter 330 may be disposed on an optical path of the light source 310 to be adjacent to the light source 310 and may filter out light of a particular wavelength band from the light emitted from the light source 310. A plurality of such light filters 330 may be provided and may each filter out light of a different wavelength band.

The detection portion 350 is configured to detect the light emitted from the light source 310 and may be selected from the group consisting of a charged-coupled device (CCD), a charge-injection device (CID), a complementary metal-oxide-semiconductor (CMOS) detector, and a photomultiplier tube (PMT).

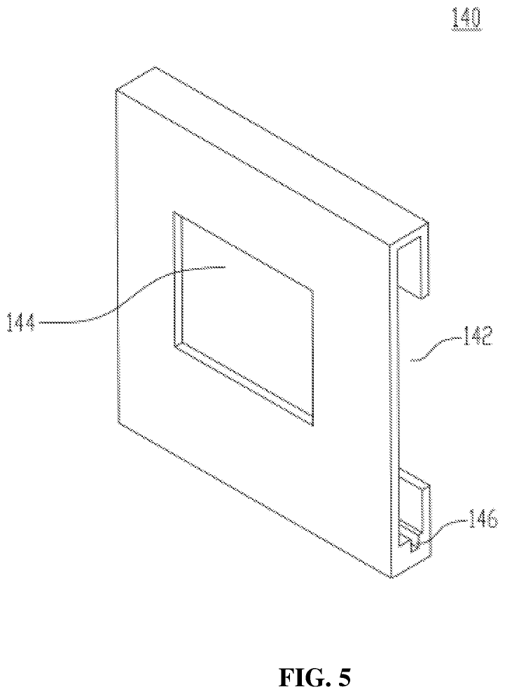

The light source 310 may be disposed between the heating blocks 112, 113, 116, and 118 and the detection portion 350 may be disposed to be opposite to the light source 310. Also, in the chip holder 140 on which the PCR chip 130 is disposed, a through portion 144 (refer to FIG. 5) may be formed in a region corresponding to the reaction chamber or the reaction channel of the PCR chip 130. Accordingly, even while the PCR chip 130 reciprocates between the first heating blocks 112 and 114 and the second heating blocks 116 and 118 and performs PCR, PCR may be measured and analyzed in real time.

In this case, an additional fluorescent material may be further added to the solution sample included in the PCR chip 130 and may emit light due to light having a particular wavelength according to production of a PCR product so as to cause a measurable and analyzable light signal.

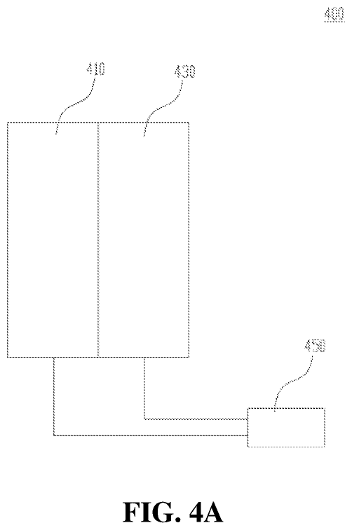

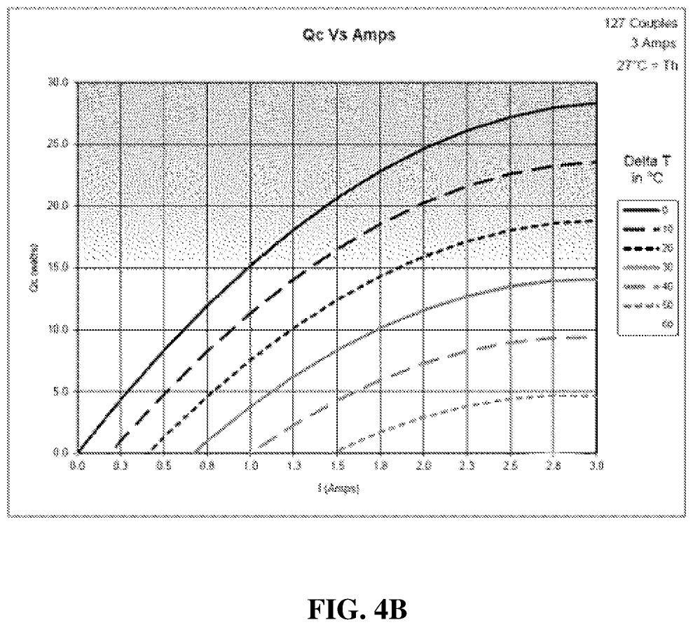

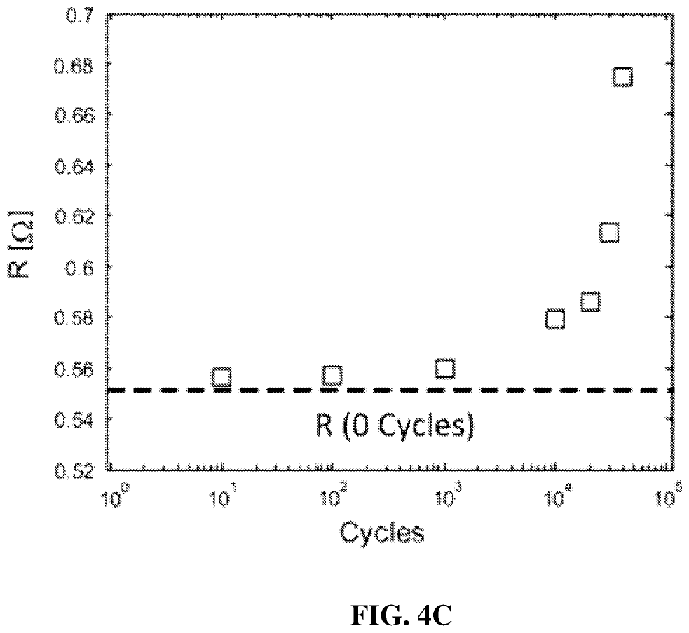

FIG. 4A illustrates a heating block according to one embodiment of the present invention, and FIGS. 4B and 4C illustrate experimental data of the heating block.

The heating block 400 of FIG. 4A is configured to implement the heating blocks 112, 114, 116, and 118 described above with reference to FIGS. 1 to 3. In detail, the heating block 400 may include a heating block 410, an auxiliary heating block 430, and a temperature control portion 450.

The main heating block 410 and the auxiliary heating block 430 are configured to generate adequate heat under the control of the temperature control portion 450 and may each include a heating wire (not shown) disposed therein. The heating wire may be disposed to be symmetrical in a vertical and/or lateral direction on the basis of a central point of each heating block surface so as to uniformly maintain an internal temperature of the heating block overall. A variety of arrangements of heating wires that are symmetrical in the vertical and/or lateral direction may be provided.

Also, the main heating block 410 and the auxiliary heating block 430 may each include a thin film heater (not shown) disposed therein. The thin film heaters may be disposed to be spaced at certain intervals apart in the vertical and/or lateral direction on the basis of the central point of each heating block surface to uniformly maintain overall internal temperatures of the main heating block 410 and the auxiliary heating block 430. A variety of certain arrangements of thin film heaters in the vertical and/or lateral direction may be provided.

To evenly distribute or quickly transfer heat with respect to the same area, the main heating block 410 and the auxiliary heating block 430 may include a metal material, for example, an aluminum material or may be formed of an aluminum material but are not limited thereto.

The temperature control portion 450 is configured to allow the first heating blocks 112 and 114 and the second heating blocks 116 and 118 to maintain temperatures for the denaturing step, the annealing step, and extension (or amplification) step of PCR and may include heat sources (that is, power sources), temperature sensors, and the like which are connected to the main heating block 410 and the auxiliary heating block 430 and configured to allow the main heating block 410 and the auxiliary heating block 430 to maintain adequate temperatures.

The main heating block 410 and the auxiliary heating block 430 may be disposed so that one surfaces thereof come into contact with each other. In detail, one surface (that is, a left side) of the main heating block 410 may come into contact with the PCR chip 130 and the other surface (that is, a right side) thereof may come into contact with the auxiliary heating block 430. Similarly, one surface (left side) of the auxiliary heating block 430 may come into contact with the main heating block 410 and the other surface (right side) thereof may be exposed outward.

That is, both the main heating block 410 and the auxiliary heating block 430 do not come into contact with the PCR chip 130. Also, only the main heating block 410 comes into contact with the PCR chip 130. The auxiliary heating block 430 may perform a function of reducing an externally exposed surface of the main heating block 410.

Here, the temperature control portion 450 may adjust temperatures of the main heating block 410 and the auxiliary heating block 430 to be different from each other. In detail, the main heating block 410 may be implemented to have a first temperature and the auxiliary heating block 430 may be implemented to have a second temperature lower than the first temperature. The second temperature is between the first temperature and ambient temperature. Accordingly, the main heating block 410, the auxiliary heating block 430, and the atmosphere have the second temperature, the first temperature, and the ambient temperature, respectively, which may gradually be decreased.

Here, the second temperature may be an intermediate temperature between the first temperature and the ambient temperature and may be lower than the first temperature, for example, by 25° C. to 35° C. For example, when the first heating blocks 112 and 114 perform the denaturing step, the first temperature may be 90° C. to 100° C. and the second temperature may be 60° C. to 70° C. Also, for example, when the first heating blocks 112 and 114 perform the annealing and extension steps, the first temperature may be 45° C. to 75° C. and the second temperature may be 25° C. to 45° C.

In this regard, referring to FIG. 4B, experimental data of the heating blocks 410 and 430 is shown. FIG. 4B illustrates heat capacity Qc according to a temperature difference delta T between the heating blocks 410 and 430 and surrounding atmosphere and a current amount I applied to the heating blocks 410 and 430. As shown in the drawing, when a difference from an ambient temperature Th=27° C. is zero, heat capacity is greatest. On the other hand, it may be seen that as the difference from the ambient temperature increases, the heat capacity is reduced the most. Here, since heat capacities of the heating blocks 410 and 430 mean heat capacities transferable to other devices adjacent to the heating blocks 410 and 430, it may be seen that as the difference from the ambient temperature decreases, heat transfer efficiency increases.

Accordingly, like the present invention, when the heating block 400 is dually disposed using the main heating block 410 and the auxiliary heating block 430 and stepwise temperatures are provided with respect thereto, heat capacities of the main heating block 410 and the auxiliary heating block 430 may increase greatly. The main heating block 410 may not come into direct contact with the atmosphere, may have an externally exposed surface reduced by the auxiliary heating block 430, and may have heat capacity corresponding to a temperature difference between the main heating block 410 and the auxiliary heating block 430. Likewise, all of both surfaces of the auxiliary heating block 430 do not come into contact with the atmosphere and one surface thereof may come into contact with the main heating block 410 so as to have heat capacity corresponding to the reduced temperature difference. Also, due to the increases in heat capacities of the main heating block 410 and the auxiliary heating block 430, a time which the heating block 400 takes to reach a target temperature set for PCR may be reduced. Also, using the increased heat capacity, a temperature change of the main heating block 410 may be minimized when heat energy is transferred to the PCR chip 130.

Also, referring to FIG. 4C, other experimental data of the heating blocks 410 and 430 is shown. FIG. 4C illustrates resistance variances caused by thermal cycling of the heating blocks 410 and 430. It may be seen that aging (or life) of the heating blocks 410 and 430 may be seen through variations of resistance values R according to the number of cycles. Here, thermal cycling is repetitively changing temperatures of the heating blocks 410 and 430 from low temperatures to high temperatures and from high temperatures to low temperatures again. As shown in the drawing, it may be seen that resistance increases according to thermal cycling. That is, the heating blocks 410 and 430 rapidly age.

However, in the present invention, since the heating block 400 is dually disposed using the main heating block 410 and the auxiliary heating block 430 and stepwise temperatures are provided with respect thereto, a range of temperature change may be reduced in thermal cycling so as to delay aging of the heating block 400. That is, a life of the heating block 400 may be significantly increased.

Although the main heating block 410 and the auxiliary heating block 430 are shown in FIG. 4A as coming into direct contact with each other, this is merely an example. According to an embodiment, the main heating block 410 and the auxiliary heating block 430 may come into indirect contact with each other due to a conductive material.

FIG. 5 illustrates the chip holder of the nucleic acid amplification device according to one embodiment of the present invention.

The chip holder 140 is configured to provide a space in which the PCR chip 130 is stably mounted and to transfer movement caused by the PCR chip driving portion 150 to the PCR chip 130. In detail, the chip holder may have a flat panel shape to allow the PCR chip 130 to be insertable while standing, may include an accommodation space 142 formed to be recessed on one side where the PCR chip 130 is insertable or dischargeable, and may be connected to the PCR chip driving portion 150 at a bottom.

The PCR chip 130 may be, for example, slidably inserted into or discharged from the accommodation space 142 while standing. Here, a guide groove 146 may be formed inside the chip holder 140 in a direction of an insertion path of the PCR chip 130. Insertion or discharge of the PCR chip 130 may be guided by the guide groove 146. To this end, according to an embodiment, the PCR chip 130 may include a guide protrusion formed corresponding to the guide groove 146 but is not limited thereto. Also, a guide protrusion 635 (refer to FIG. 7) corresponding to the guide groove 146 is formed on a PCR package (particularly, a PCR chip case 600) such that movement during a process of inserting and discharging the PCR package in which the PCR chip 130 is included may be performed more smoothly.

The through portion 144 may be formed in the chip holder 140. The through portion 144 corresponds to the reaction chamber or reaction channel of the PCR chip 130 inserted in the chip holder 140, and the heating block may come into thermal contact with the PCR chip 130 through the through portion 144. Also, as described above with reference to FIG. 3, when the chip holder 140 moves between the first heating blocks 112 and 114 and the second heating blocks 116 and 118, a PCR result may be detected using the light source 310, the detection portion 350, and the like in real time.

A shape of the chip holder 140 shown in FIG. 5 is merely an example, and a variety of components may be applied according to an embodiment to which the present invention is applied. For example, according to an embodiment, the chip holder 140 may further include a fixing member (not shown) configured to prevent the PCR chip 130 inserted therein from being detached therefrom.

FIGS. 6 to 8B illustrate the PCR chip package according to one embodiment of the present invention.

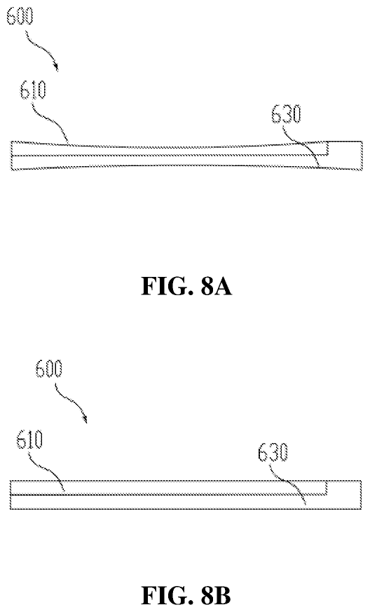

In detail, FIG. 6 is an assembling view of the PCR chip package, FIG. 7 is an exploded view of the PCR chip package, and FIGS. 8A and 8B illustrate the PCR chip before and after being assembled.

The PCR chip package may accommodate the PCR chip 130 therein, be inserted into the chip holder 140, move with the chip holder 140, and allow the PCR chip 130 to come into more stable and firmer contact with the heating blocks. Also, the PCR package may prevent a leakage of the solution sample included in the PCR chip 130 during a PCR process. To this end, the PCR chip package may include the PCR chip 130, the PCR chip case 600, and a sealing portion 700.

The PCR chip 130 may include a solution sample including nucleic acid, for example, double-stranded DNA, oligonucleotide primer having a complementary nucleic sequence to a particular nucleic sequence to be amplified, DNA polymerase, dNTP, and a PCR buffer.

The PCR chip 130 may include an inlet portion configured to introduce the solution sample, an outlet portion configured to discharge the solution sample on which nucleic acid amplification reaction is completed, and one or more PCR chambers (or channels) which accommodate the solution sample including nucleic acid to be amplified. The PCR chip 130 may be implemented using a light transmitting material and, preferably, includes a light transmitting plastic material. For example, since a plastic material is used, the PCR chip 130 may facilitate an increase in heat transfer efficiency by adjusting a thickness of plastic and manufacturing costs thereof may be reduced due to a simple manufacturing process. However, the present invention is not limited thereto.

Particularly, since the PCR chip 130 is implemented as a chip type as shown in the drawings, a smaller amount of solution sample than a tube type is accommodated in the reaction chamber and an area in contact with the heating block increases so that heat transfer efficiency from the heating block may be increased.

Protruding regions 132 which protrude further than surroundings thereof may be formed in an adjacent region including the inlet portion and the outlet portion of the PCR chip 130. Accommodation regions 750 corresponding to the protruding regions 132 may be formed in the sealing portion 700 coupled to the PCR chip 130 so as to allow the PCR chip 130 and the sealing portion 700 to be stably coupled to each other and to prevent an alignment thereof from being in disorder even when an external force is applied.

Also, at least one fixing protrusion 134 may be formed on the PCR chip 130. Like the protruding regions 132, to maintain coupling and alignment with the sealing portion 700, the sealing portion 700 may include at last one first fixing hole 770 at a corresponding position. Particularly, the fixing protrusion 134 and the first fixing hole 770 may be formed to have different shapes to fit each other while being coupled so as to be more firmly coupled to the PCR chip 130 to the sealing portion 700.

The PCR chip case 600 may include a top plate 610 and a bottom plate 630 and may be opened or closed through hinge-pivoting between the top plate 610 and the bottom plate 630. In an open state, the PCR chip 130 and/or the sealing portion 700 may be accommodated in or eliminated from the PCR chip case 600. In a closed state, the PCR chip 130 and/or the sealing portion 700 therein may be pressurized to be stably disposed. Also, through sliding of a coupling member 650, the top plate 610 and the bottom plate 630 may selectively remain in the closed state or the open state. However, the function and operation of the coupling member 650 are merely an example, and a variety of components may be applied according to an embodiment to which the present invention is applied.

To accommodate the PCR chip 130 in the PCR chip case 600, accommodation spaces 612 and 631 in which the PCR chip 130 is mounted may be formed in one inner surfaces of the top plate 610 and the bottom plate 630. The accommodation spaces 612 and 631 may be formed to have sizes corresponding to or larger than the PCR chip 130 coupled to the sealing portion 700. That is, the accommodation spaces 612 and 631 may form a certain gap from the sealing portion 700 and the PCR chip 130. Accordingly, the PCR chip 130 coupled to the sealing portion 700 may be easily disposed in the accommodation spaces 612 and 631. Similarly, after PCR, the PCR chip 130 coupled to the sealing portion 700 may be easily eliminated from the PCR chip case 600. Particularly, since side surfaces of the accommodation spaces 612 and 631 do not fit on or come into contact with the sealing portion 700, it is possible to prevent the sealing portion 700 from moving in relation to the top plate 610 and/or the bottom plate 630 due to the side surfaces of the accommodation spaces 612 and 631 or from being eliminated from the PCR chip 130 when the PCR chip case 600 is opened.

As described above, since a state in which the sealing portion 700 is coupled to the PCR chip 130 is maintained before and after PCR, it is possible to prevent the solution sample (particularly, a solution sample amplified at high concentration and including a fluorescent material or the like which is harmful to a human body) from leaking out from the PCR chip 130 so as to prevent a human body from being exposed to the solution sample on the sealing portion 700 and the solution sample doing harm thereto, or to prevent the solution sample from being exposed to the air or PCR equipment so as to distort another PCR result after PCR is completed.

The guide protrusion 635 is one region of the bottom plate 630 of the PCR chip case 600 which protrudes outward and may correspond to the guide groove 146 of the chip holder 140. Accordingly, when the PCR chip case 600 is inserted into or discharged from the chip holder 140, a movement path may be guided so as to allow the PCR chip case to easily move. The guide protrusion 635 is shown in the drawing as being formed on the bottom plate 630 but is not limited thereto and may be formed on the top plate 610 or on both the top plate 610 and the bottom plate 630.

Also, a second fixing hole 637 may be formed in the PCR chip case 600. The second fixing hole 637 corresponds to the fixing protrusion and the first fixing hole and allows the fixing protrusion of the PCR chip to pass through the first fixing hole and then to pass through or be accommodated in the second fixing hole so that the sealing portion 700 may adequately pressurize the PCR chip even when the fixing protrusion has a length adequate for (that is, corresponding to or larger than) the first fixing hole of the fixing protrusion. Particularly, since an adsorption force between the sealing portion 700 and bottom surfaces of the accommodation spaces 612 and 631 are removed or reduced by air communication of the fixing hole 637 when the sealing portion 700 is eliminated from the PCR chip case 600, it is possible to prevent the sealing portion 700 from moving in relation to the top plate 610 and/or the bottom plate 630 or from being eliminated from the PCR chip 130 due to the bottom surfaces of the accommodation spaces 612 and 631 when the PCR chip case 600 is opened.

Meanwhile, the PCR chip case 600 may include an alignment protrusion 639 formed therein.

The alignment protrusion 639 corresponds to an alignment hole 790 of the sealing portion 700. Since the alignment protrusion 639 is inserted into the alignment hole 790, the alignment of the sealing portion 700 may be maintained even when the sealing portion 700 is disposed with a gap from the accommodation spaces 612 and 631.

Also, when the PCR chip case 600 is closed, the PCR chip 130 may be fixedly pressurized using the sealing portion 700 which is soft. Accordingly, it is possible to prevent the PCR chip 130 from being deformed by stress generated when the PCR chip 130 comes into contact with the heating blocks 112, 114, 116, and 118.

Particularly, referring to FIG. 8A, the PCR chip case 600 may have a shape in which the top plate 610 and the bottom plate 630 are curved to be concave toward each other. Subsequently, when the sealing portion 700 and the PCR chip 130 are mounted in the PCR chip case 600 and the top plate 610 and the bottom plate 630 are closed, the sealing portion 700 and the PCR chip 130 are coupled to each other and the top plate 610 and the bottom plate 630 may be deformed as flat panels (refer to FIG. 8B). This is because an external force is applied, by the sealing portion 700 and the PCR chip 130 thereinside, to the top plate 610 and the bottom plate 630 in an outward direction when the top plate 610 and the bottom plate 630, which are curved to be concave toward each other, are closed. This is to form a space between the top plate 610 and the bottom plate 630 to correspond to or be smaller than the PCR chip 130 coupled to the sealing portion 700 so as to fixedly pressurize the PCR chip 130 using the sealing portion 700, which is soft, when the PCR chip case 600 is closed, and this is to improve efficiency in contact with the heating blocks 112, 114, 116, and 118 by forming outer surfaces of the top plate 610 and the bottom plate 630 to be flat.

Also, to allow PCR to be observable while the PCR chip 130 is disposed in the PCR chip case 600 or the chip holder 140, the top plate 610 and the bottom plate 630 may include open regions 614 and 633 formed corresponding to the reaction chamber of the PCR chip 130. Also, the PCR chip 130 may come into close contact with the heating blocks 112, 114, 116, and 118 through the open regions 614 and 633 of the top plate 610 and the bottom plate 630.

A support portion 616 protruding toward the bottom plate 630 may be formed on the top plate 610 of the PCR chip case 600. Also, a recessed space into which the support portion 616 is inserted may be formed at a position of the bottom plate 630 which corresponds to the support portion 616. When the PCR chip case 600 is folded and bound, it is possible to provide the PCR chip case 600 with strength through the support portion 616 so as to prevent shape deformation.

The sealing portion 700 may seal the inlet portion and the outlet portion of the PCR chip 130.

To this end, the sealing portion 700 may include a soft material such as rubber and the like and have flexibility and elasticity. In detail, the sealing portion 700 may include a cover portion 710 having a flat panel shape and a plurality of protruding portions 730 formed on the cover portion 710, and each of the protruding portions 730 may be inserted into the inlet portion and the outlet portion of the PCR chip 130 so as to seal the PCR chip 130.

Also, the sealing portion 700 and the PCR chip 130 may have corresponding shapes to be more firmly pressed against each other. For example, the accommodation regions 750 corresponding to the protruding regions 132 which surround the inlet portion and the outlet portion of the PCR chip 130 may be formed and the first fixing holes 770 corresponding to the fixing protrusions 134 of the PCR chip 130 may be formed. Also, the sealing portion 700 may be coupled to the PCR chip case 600 through the alignment hole 790 to maintain alignment thereof.

As described above, optimum embodiments have been shown and described in the drawings and the specification. The particular terms used herein are merely intended to describe the present invention and are not used to limit the meanings or restrict the scope of the present invention disclosed in the claims. Therefore, it should be understood by one of ordinary skill in the art that a variety of modifications and equivalents thereof may be made. Accordingly, the technical scope of the present invention should be determined by the technical concept of the following claims.

1. A nucleic acid amplification device comprising:
a polymerase chain reaction (PCR) chip driving portion configured to allow a PCR chip to reciprocate between a first position and a second position;
a plurality of first heating blocks disposed to be spaced apart with the first position as a center and to face each other;
a plurality of second heating blocks disposed to be spaced apart with the second position as a center and to face each other; and
a heating block driving portion configured to move the plurality of first heating blocks and the plurality of second heating blocks toward the PCR chip,
wherein both surfaces of the PCR chip come into contact with the plurality of first heating blocks at the first position and the both surfaces come into contact with the plurality of second heating blocks at the second position so as to perform PCR.

2. The nucleic acid amplification device of claim 1, wherein the plurality of first heating blocks are implemented to maintain a temperature of a denaturing step of the PCR or to maintain a temperature of annealing and extension steps of the PCR,
wherein the plurality of second heating blocks are implemented to maintain the temperature of annealing and extension steps of the PCR or maintain the temperature of the denaturing step of the PCR, and
wherein the plurality of first heating blocks and the plurality of second heating blocks are implemented to maintain temperatures of different steps.

3. The nucleic acid amplification device of claim 2, wherein the temperature of the denaturing step is 90° C. to 100° C., and the temperature of the annealing and extension steps is 45° C. to 75° C.

4. The nucleic acid amplification device of claim 1, wherein each of the heating blocks further comprises:
a main heating block having one surface coming into contact with the PCR chip; and
an auxiliary heating block having one surface coming into contact with the other surface of the main heating block and having the other surface exposed outward.

5. The nucleic acid amplification device of claim 4, wherein the main heating block is implemented to have a first temperature, and
wherein the auxiliary heating block is implemented to have a second temperature lower than the first temperature.

6. The nucleic acid amplification device of claim 5, wherein the first temperature is 90° C. to 100° C., and the second temperature is 60° C. to 70° C.

7. The nucleic acid amplification device of claim 5, wherein the first temperature is 45° C. to 75° C., and the second temperature is 25° C. to 45° C.

8. The nucleic acid amplification device of claim 5, wherein the second temperature is lower than the first temperature by 25° C. to 35° C.

9. The nucleic acid amplification device of claim 1, wherein the second temperature is between the first temperature and ambient temperature.

10. The nucleic acid amplification device of claim 1, further comprising the PCR chip comprising:
an inlet portion into which a solution sample is injected;
a reaction chamber in which PCR of the solution sample is performed; and
an outlet portion through which the solution sample is discharged.

11. The nucleic acid amplification device of claim 10, further comprising a PCR chip case configured to accommodate the PCR chip, expose the reaction chamber of the PCR chip to the outside, and reciprocate due to the PCR chip driving portion.

12. The nucleic acid amplification device of claim 11, further comprising a sealing portion having a soft material, coupled to the PCR chip to seal the inlet portion and the outlet portion of the PCR chip, and accommodated in the PCR chip case.

13. A nucleic acid amplification device comprising a plurality of heating blocks disposed to be spaced apart and configured to come into contact with a PCR chip to perform PCR,
wherein each of the heating blocks comprises:
a main heating block having one surface coming into contact with the PCR chip; and
an auxiliary heating block having one surface coming into contact with the other surface of the main heating block and having the other surface exposed outward.

14. The nucleic acid amplification device of claim 13, wherein the main heating block is implemented to have a first temperature, and
wherein the auxiliary heating block is implemented to have a second temperature lower than the first temperature.
